(19) United States
(12) Patent Application Publication
(10) Pub. No.: US 2024/0421952 A1
(43) Pub. Date: Dec. 19, 2024

(54) METHODS AND APPARATUS FOR SSB DETECTION

(71) Applicant: LENOVO (BEIJING) LIMITED, Beijing (CN)

(72) Inventors: Yuantao ZHANG, Beijing (CN); Hongmei LIU, Beijing (CN); Zhi YAN, Beijing (CN); Yingying LI, Beijing (CN); Ran YUE, Beijing (CN); Haiming WANG, Beijing (CN)

(21) Appl. No.: 18/703,866

(22) PCT Filed: Oct. 29, 2021
(86) PCT No.: PCT/CN2021/127472

§ 371 Date: Apr. 23, 2024

(51) Int. Cl. H04L 5/00; H04W 48/10

(52) U.S. Cl. CPC H04L 5/0048; H04L 5/0053; H04W 48/10

(57) ABSTRACT

The present application relates to methods and apparatus for SSB detection. One embodiment of the present disclosure provides a user equipment (UE), which includes: a processor configured to: determine at least one of a value of a first parameter and a configuration of a first control resource set (CORESET) associated with a first synchronization signal block (SSB); determine a type of the first SSB based on at least one of the value of the first parameter and the configuration of the first CORESET; and determine a cell defining SSB for the UE based on the type of the first SSB; or determine a frequency range for searching the cell defining SSB for the UE based on the type of the first SSB.

### TECHNICAL FIELD

The present disclosure relates to wireless communication technology, especially to methods and apparatus for synchronization signal and physical broadcast channel (PBCH) block (SSB) detection.

### BACKGROUND OF THE INVENTION

When a new radio (NR) UE is powered on, it tries to access to the network, and it needs to detect the SSBs first, so as to obtain the configurations in the master information block (MIB), and then starts to detect downlink control information (DCI) in the control resources set (i.e. CORESET #0) for system information block 1 (SIB1) scheduling.

In NR frequency range 1 (FR1, carrier frequency <7.125 GHz), the SSBs and CORESET #0 can be configured with the same or different subcarrier spacing (SCS). The SCS for SSBs is frequency band dependent, where most bands support only 15 kHz SCS SSBs, and a few bands support SSBs with both 15 kHz and 30 kHz SCS. The CORESET #0 can be configured with either 15 kHz SCS or 30 kHz SCS in each band.

The NR reduced capability (NR RedCap) user equipment (UE) is introduced in 3^{rd} generation partnership project (3GPP) since Release 17, which is designed to have lower end capabilities, lower cost, lower complexity (e.g., reduced bandwidth and number of antennas), and a longer battery life. For example, the bandwidth of the RedCap UEs is smaller compared to the bandwidth of the non-RedCap UEs.

Therefore, the RedCap UEs may not be able to be compatible with SSBs with 30 kHz SCS or the CORESET #0 with 30 kHz SCS, which may occupy a bandwidth larger than the bandwidth of the RedCap UEs, while the network may not always use configurations compatible with the RedCap UEs.

Accordingly, it is describe to provide solutions for the RedCap UEs to determine the SSBs in the case that the SSBs and/or CORESET #0 are not compatible with the RedCap UEs.

### SUMMARY

One embodiment of the present disclosure provides a user equipment (UE), which includes: a processor configured to: determine at least one of a value of a first parameter and a configuration of a first control resource set (CORESET) associated with a first synchronization signal block (SSB); determine a type of the first SSB based on at least one of the value of the first parameter and the configuration of the first CORESET; and determine a cell defining SSB for the UE based on the type of the first SSB; or determine a frequency range for searching the cell defining SSB for the UE based on the type of the first SSB.

In some embodiments, the processor is further configured to: determine the type of the first SSB is the cell defining SSB for the UE when the first parameter is within a range from 0 to 11, and the configuration indicates the first CORESET is configured with a subcarrier spacing (SCS) of 15 kHz and 24 resource blocks.

In some embodiments, the processor is further configured to: determine the type of the first SSB is not the cell defining SSB for the UE and detecting a second CORESET and/or a second SSB when the first parameter is within a range from 0 to 11, and the configuration indicates the first CORESET is configured with a subcarrier spacing (SCS) of 15 kHz and 48 or 96 resource blocks.

In some embodiments, the processor is further configured to: determine the type of the first SSB is not the cell defining SSB for the UE and detecting a second CORESET and/or a second SSB when the first parameter is within a range from 0 to 23, and the configuration indicates the first CORESET is configured with a subcarrier spacing (SCS) of 30 kHz.

In some embodiments, the processor is further configured to: determine the type of the first SSB is not a cell defining SSB for the UE; determine a second SSB based on the first SSB; determine whether the second SSB is a cell defining SSB for the UE based on a field in broadcast information; and detect the second SSB if it is a cell defining SSB; or detect a cell defining SSB for the UE if the second SSB is not the cell defining SSB.

In some embodiments, the processor is further configured to: determine the type of the first SSB is not a cell defining SSB for the UE; determine whether there is a cell defining SSB for the UE within the frequency range based on a field in broadcast information; and detect the cell defining SSB for the UE within the frequency range; or detect a cell defining SSB for the UE out of the frequency range.

In some embodiments, the processor is further configured to: determine the type of the first SSB is not a cell defining SSB for the UE; determine a frequency offset for a cell defining SSB for the UE based on one or more fields in broadcast information; and detect a cell defining SSB for the UE based on the frequency offset.

In some embodiments, the frequency offset is associated with a frequency position of the first SSB.

In some embodiments, the frequency offset is associated with a frequency position of a second SSB.

In some embodiments, the processor is further configured to: determine the first SSB as a cell defining SSB for the UE if the first parameter is within a range from 12 to 23.

In some embodiments, a subcarrier offset between a first resource block (RB) of the first SSB and a common RB is the first parameter minus 12.

In some embodiments, a dedicated master information block in the first SSB indicates a dedicated CORESET for the UE.

In some embodiments, a configuration of the dedicated CORESET includes less resource blocks (RB) than 24 RBs and/or more than 3 orthogonal frequency division multiplexing (OFDM) symbols.

In some embodiments, a starting position of the dedicated CORESET for the UE is higher than a starting position of the first SSB in frequency domain.

Another embodiment of the present disclosure provides a base station (BS), which includes: a processor configured to: determine whether a first SSB is a cell defining SSB for a user equipment (UE) based on at least one of a value of a first parameter and a configuration of a first control resource set (CORESET) associated with a first synchronization signal block (SSB); and in case the first SSB is not the cell defining SSB for the UE, determine a cell defining SSB for the UE based on the first SSB, or determine a frequency range for transmitting the cell defining SSB for the UE; and a transceiver configured to: transmit the first SSB; and transmitting the cell defining SSB for the UE in case the first SSB is not the cell defining SSB for the UE.

In some embodiments, the processor is further configured to: determine a dedicated CORESET for the UE in a dedicated master information block in the first SSB.

In some embodiments, a configuration of the dedicated CORESET includes less RB than 24 RBs and/or more than 3 OFDM symbols.

In some embodiments, a starting position of the dedicated CORESET for the UE is higher than a starting position of the first SSB in frequency domain.

One embodiment of the present disclosure provides a method performed by a UE, which includes: determining at least one of a value of a first parameter and a configuration of a first control resource set (CORESET) associated with a first synchronization signal block (SSB); determining a type of the first SSB based on at least one of the value of the first parameter and the configuration of the first CORESET; and determining a cell defining SSB for the UE based on the type of the first SSB; or determining a frequency range for searching the cell defining SSB for the UE based on the type of the first SSB.

Another embodiment of the present disclosure provides a method performed by a BS, which includes: determining whether a first SSB is a cell defining SSB for a user equipment (UE) based on at least one of a value of a first parameter and a configuration of a first control resource set (CORESET) associated with a first synchronization signal block (SSB); transmit the first SSB; in case the first SSB is not the cell defining SSB for the UE, determining a cell defining SSB for the UE based on the first SSB, or determining a frequency range for transmitting the cell defining SSB for the UE; and transmitting the cell defining SSB for the UE.

### BRIEF DESCRIPTION OF THE DRAWINGS

FIG. 1 illustrates a schematic diagram of a wireless communication system according to some embodiments of the present disclosure.

FIG. 2 illustrates an exemplary NR SSB structure according to some embodiments of the present disclosure.

FIGS. 3A and 3B illustrate two examples of determining the position of CORESET #0 in frequency domain based on the position of the detected SSB according to some embodiments of the present disclosure.

FIG. 4 illustrates an example of determining the position of CORESET #0 in frequency domain based on the position of the detected SSB according to some embodiments of the present disclosure.

FIG. 5 illustrates a method performed by a UE for wireless communication according to some embodiments of the present disclosure.

FIG. 6 illustrates a method performed by a BS for wireless communication according to some embodiments of the present disclosure.

FIG. 7 illustrates a simplified block diagram of an exemplary apparatus 700 according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that all illustrated operations be performed, to achieve desirable results, sometimes one or more operations can be skipped. Further, the drawings can schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

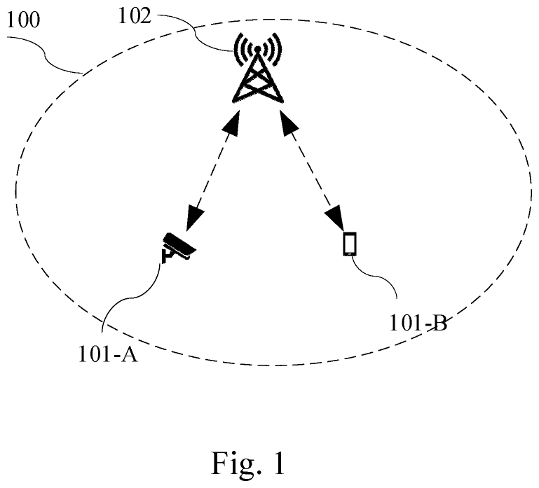

FIG. 1 illustrates an exemplary wireless communication system according to some embodiments of the present disclosure.

As shown in FIG. 1, the wireless communication system includes a base station, i.e., BS 102 and some UEs, i.e., UE 101-A and UE 101-B. UE 101-A and UE 101-B are within the coverage of BS 102. UE 101-A may be the first type of UE, e.g., a RedCap UE, and UE 101-B may be the second type of UE, e.g., non-RedCap UEs such as a legacy enhanced mobile broadband (eMBB) or an ultra-reliable and low latency communications (URLLC) UE. It is contemplated that, in accordance with some other embodiments of the present disclosure, a wireless communication system may include more or fewer BSs, and more or fewer UEs. Moreover, it is contemplated that names of UEs as illustrated and shown in FIG. 1 may be different, e.g., UE 101c, UE 104f, and UE 108g or the like.

In addition, although the RedCap UE, i.e. UE 101-A, as shown in FIG. 1 is illustrated in the shape of a camera, it is contemplated that a communication system may include any type of RedCap UE in accordance with some other embodiments of the present disclosure. For example, the UE 101-A may include industrial wireless sensors, video surveillances, wearables, computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, the UE 101-A may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 101-A include wearable devices, such as smart watches, fitness bands, optical head-mounted displays, or the like. Moreover, the UE 101-A may be referred to as a subscriber unit, a mobile, a mobile station, a user, a terminal, a mobile terminal, a wireless terminal, a fixed terminal, a subscriber station, a user terminal, or a device, or described using other terminology used in the art. The UE 101-A may communicate directly with the BSs 102 via uplink (UL) communication signals.

Both UE 101-A and UE 101-B in the embodiments of FIG. 1 may transmit information to BS 102 and receive control information from BS 102, for example, via NR Uu interface. BS 102 may define one or more cells, and each cell may have a coverage area. As shown in FIG. 1, both UE 101-A and UE 101-B are within the coverage of BS 102.

BS 102 as illustrated and shown in FIG. 1 is not a specific base station, but may be any base station(s) in the communication system. For example, if the communication system includes two BSs 102, UE 101-A being within a coverage area of any one the two BSs 102 may be considered that UE 101-A is within a coverage of BS 102 in the communication system; and only UE 101-A being outside of coverage area(s) of both BSs 102 can be called as a case that UE 101-A is outside of the coverage of BS 102 in the communication system.

The BSs 102 may be distributed over a geographic region. In certain embodiments, each of the BSs 102 may also be referred to as an access point, an access terminal, a base, a macro cell, a Node-B, an enhanced Node B (eNB), a gNB, a Home Node-B, a relay node, or a device, or described using other terminology used in the art. The BSs 102 are generally part of a radio access network that may include one or more controllers communicably coupled to one or more corresponding BSs 102.

The wireless communication system is compatible with any type of network that is capable of sending and receiving wireless communication signals. For example, the wireless communication system is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3rd generation partnership project (3GPP)-based network, a 3GPP 5G network, a satellite communications network, a high altitude platform network, and/or other communications networks.

In one embodiment, the wireless communication system is compatible with the 5G new radio (NR) of the 3GPP protocol, wherein the BS 102 may transmit data using an orthogonal frequency division multiplexing (OFDM) modulation scheme on the DL and the UEs transmit data on the UL using a single-carrier frequency division multiple access (SC-FDMA) or OFDM scheme. More generally, however, the wireless communication system may implement some other open or proprietary communication protocols, for example, WiMAX, among other protocols.

In other embodiments, the BS 102 may communicate using other communication protocols, such as the IEEE 802.11 family of wireless communication protocols. Further, in some embodiments, the BS 102 may communicate over licensed spectrums, whereas in other embodiments the BS 102 may communicate over unlicensed spectrums. The present disclosure is not intended to be limited to the implementation of any particular wireless communication system architecture or protocol. In another embodiment, the BS 102 may communicate with the UEs using the 3GPP 5G protocols.

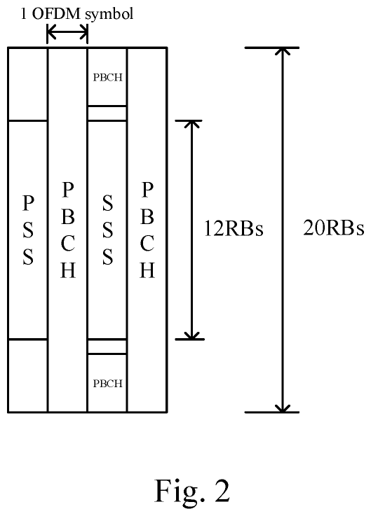

FIG. 2 illustrates an exemplary NR SSB structure according to some embodiments of the present disclosure. It is noted in actual network, multiple SSBs might be transmitted, each with different transmit beams. From UE point of view, typically it detects one SSB with the best channel quality out of the SSBs.

One SSB occupies 4 consecutive OFDM symbols in time domain and 20 RBs in frequency domain, each RB includes 12 subcarriers, therefore, the SSB occupies 240 carriers in frequency domain. The four OFDM symbols includes a primary synchronization signal (PSS), a secondary synchronization signal (SSS) and a physical broadcast channel (PBCH), which carries master information block (MIB). The PBCH not only carries MIB, but also carries an 8-bit physical layer (PHY) layer payload.

According to 3GPP documents, MIB is defined as follows:

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |
| } | |

The second parameter, i.e. SubcarrierSpacingCommon and the fifth parameter, i.e. pdcch-ConfigSIB1, are configurations regarding a CORESET with index 0, i.e., CORESET #0. CORESET #0 is used to accommodate downlink control information (DCI) for scheduling remaining system information (RMSI, i.e., system information block 1, SIB1).

Specifically, the parameter SubcarrierSpacingCommon in MIB configures the SCS of CORESET #0. The parameter pdcch-ConfigSIB1 configures the bandwidth, the duration in time domain and the resource block (RB) level offsets of CORESET #0. The bandwidth of CORESET #0 may be 24 RBs, 48 RBs, or 96 RBs. The duration in time domain of CORESET #0 may be 1 OFDM symbol, 2 OFDM symbols, or 3 OFDM symbols. The RB level offset is defined with respect to the SCS of the CORESET #0, from the smallest RB index of the CORESET #0 to the smallest RB index of the common RB overlapping with the first RB of the corresponding SSB.

Table 1 below provides an example of CORESET #0 configurations according to some embodiments of the present disclosure.

TABLE 1
CORESET#0 configurations

| | Number | Number of | Offset |
|---|---|---|---|
| Index | of RBs | Symbols | (RBs) |
| 0 | 24 | 2 | 0 |
| 1 | 24 | 2 | 2 |
| 2 | 24 | 2 | 4 |
| 3 | 24 | 3 | 0 |
| 4 | 24 | 3 | 2 |
| 5 | 24 | 3 | 4 |
| 6 | 48 | 1 | 12 |
| 7 | 48 | 1 | 16 |
| 8 | 48 | 2 | 12 |
| 9 | 48 | 2 | 16 |
| 10 | 48 | 3 | 12 |
| 11 | 48 | 3 | 16 |
| 12 | 96 | 1 | 38 |
| 13 | 96 | 2 | 38 |
| 14 | 96 | 3 | 38 |

| | |
|---|---|
| 15 | reserved |

For example, if the parameter, pdcch-ConfigSIB1, in the MIB has a value of 0, according to table 1, the CORESET #0 is configured with 24 RBs in frequency domain, 2 symbols in time domain, and the offset is 0. The value 15 is reserved.

For a UE accessing to the network, the UE first detects SSB, gets the configurations in MIB, and then starts to detect DCI in CORESET #0 for SIB1 scheduling.

However, not all SSBs include valid configurations for CORESET #0. NR supports two types of SSBs. The first type of SSBs are cell defining SSBs (CD-SSB) and the second type of SSBs are measurement SSBs, which are SSBs for measurement only. The MIB included in a CD-SSB contains valid configurations for CORESET #0, while MIB in a measurement SSB does not contain valid CORESET #0 configurations.

The CD-SSB and the measurement SSB are differentiated by different values of a parameter k_{SSB}, which is a 5-bit parameter and indicates the subcarrier offset from the lowest subcarrier of SSB to the closest subcarrier 0 of the common PRB.

For FR1, the 4 least significant bits (LSBs) of k_{SSB} are indicated by the third parameter in MIB, i.e. ssb-SubcarrierOffset, and 1 most significant bit (MSB) is carried in the physical layer payload of PBCH.

Specifically, if k_{SSB} is within [0, 23], the SSB is a CD-SSB. If k_{SSB} is within [24, 31], the SSB is for measurement only, i.e., the measurement SSB.

For CD-SSB, the UE could determine the frequency domain position of CORESET #0 based on the two above offsets, i.e., subcarrier offset, i.e., the parameter k_{SSB} (which is defined using 15 kHz SCS), and the RB level offset (which is defined using the RBs of CORESET #0) in CORESET #0 configurations.

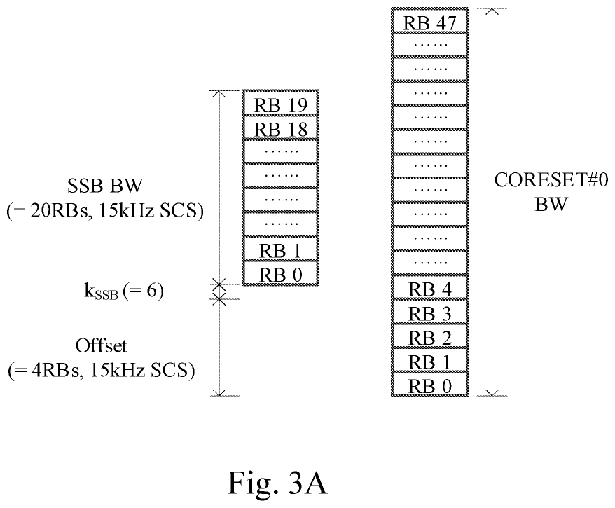

FIGS. 3A and 3B illustrate two examples of determining the position of CORESET #0 in frequency domain based on the position of the detected SSB according to some embodiments of the present disclosure.

In FIG. 3A, both the SSB and CORESET #0 have 15 kHz SCS. The SSB is configured with 20 RBs, which are referred to as RB 0, RB 1, . . . , RB 19. CORESET #0 is configured with 48 RBs, which are referred to as RB 0, RB 1, . . . , RB 47.

One CORESET #0 RB occupies a frequency range corresponding to 1 SSB RB. The RB level offset is 4 RBs, counting using one CORESET #0 RB as the unit. The subcarrier offset is 6 subcarriers, and it is countered using 15 kHz as a unit. Therefore, the total offset in frequency domain is: 4 CORESET #0 RBs and 6 subcarriers. With the total offset, the UE can determine the position of CORESET #0 in frequency domain based on the position of the detected SSB.

In FIG. 3B, the SSB SCS is 15 kHz, and CORESET #0 SCS is 30 kHz. The SSB is configured with 20 RBs, which are referred to as RB 0, RB 1, . . . , RB 19.CORESET #0 is configured with 24 RBs, which are referred to as RB 0, RB 1, . . . , RB 23. One CORESET #0 RB occupies a frequency range of two SSB RBs. The RB level offset is 4 RBs, counting using one CORESET #0 RB as the unit, and the subcarrier offset is 15 subcarriers, counting using 15 kHz numerology. Therefore, the total offset in frequency domain is: 4 CORESET #0 RBs and 15 subcarriers.

According to FIGS. 3A and 3B, it can be seen that the size of one CORESET #0 RB may be equal to or twice the size of one SSB RB in frequency domain. For example, in FIG. 3A, the size of the CORESET #0 RB is equal to the size of one SSB RB in frequency domain, and in FIG. 3B, the size of the CORESET #0 RB is or twice the size of one SSB RB in frequency domain. Since one RB includes 12 carriers, the size of the CORESET #0 RB corresponds to 12 SSB subcarriers in FIG. 3A, and the size of the CORESET #0 RB corresponds to 24 SSB subcarriers in FIG. 3B. As can be seen, the offset between the closest CORESET #0 RB and the SSB RB ranges from 0 to 23. Therefore, if the subcarrier offset, i.e. k_{SSB} is within [0, 23], the SSB is a CD-SSB.

Furthermore, in FIG. 3A, when CORESET #0 is configured with 15 kHz SCS, and the size of CORESET #0 RB corresponds to 12 SSB subcarriers, the value of the parameter k_{SSB} is within [0, 11]. In this case, if k_{SSB} is configured in a range [12, 23], the UE cannot interpret this SSB and will take it as an error case and ignore this SSB.

In FIG. 3B, the CORESET #0 is configured with 30 kHz SCS, and the size of the CORESET #0 RB corresponds to 24 SSB subcarriers, thus the value of the parameter k_{SSB} is within [0, 23].

When the parameter k_{SSB} is within [24, 31], the SSB is for measurement only. The parameter k_{SSB} is not for indicating a subcarrier offset, and the parameter, pdcch-ConfigSIB1, in the MIB does not indicate valid CORESET #0 configurations. Instead, they help the UE to get the information regarding the position of a CD-SSB.

Specifically, if 24≤k_{SSB}≤30, the UE may determine a CD-SSB with the nearest global synchronization channel number (GSCN) as:

N_{GSCN}^{Reference}+N_{GSCN}^{offset}

where N_{GSCN}^{Reference} is the GSCN of the measurement SSB, and N_{GSCN}^{offset} is a GSCN offset, which is determined by CORESET #0 configuration referred to as controlResourceSetZero, and the search space #0 configuration referred to as: searchSpaceZero, in the parameter pdcch-ConfigSIB1 in MIB. Table 2 below shows how N_{GSCN}^{offset} is determined by CORESET #0 and searchSpaceZero for FR1.

TABLE 2
Mapping between the combination of k_{SSB} and controlResourceSetZero
and searchSpaceZero in MIB to N_{GSCN}^{offset} for FR1

| | 16 × | |
|---|---|---|
| | controlresourcesetzero + | |
| k_{SSB} | searchspacezero | N_{GSCN}^{offset} |
| 24 | 0, 1, . . . , 255 | 1, 2, . . . , 256 |
| 25 | 0, 1, . . . , 255 | 257, 258, . . . , 512 |
| 26 | 0, 1, . . . , 255 | 513, 514, . . . , 768 |
| 27 | 0, 1, . . . , 255 | −1, −2, . . . , −256 |
| 28 | 0, 1, . . . , 255 | −257, −258, . . . , −512 |
| 29 | 0, 1, . . . , 255 | −513, −514, . . . , −768 |
| 30 | 0, 1, . . . , 255 | Reserved, Reserved, . . . , Reserved |

For example, if the value of k_{SSB} is 24, and the value of 16×controlresourcesetzero+searchspacezero is 0, then the value of N_{GSCN}^{offset} is 1, when the value of 16×controlresourcesetzero+searchspacezero is 1, then the value of N_{GSCN}^{offset} is 2, etc. If the value of k_{SSB} is 26, and the value of 16×controlresourcesetzero+searchspacezero is 0, then the value of N_{GSCN}^{offset} is 513, the value of 16×controlresourcesetzero+searchspacezero is 1, then the value of N_{GSCN}^{offset} is 514, etc.

Else if K_{SSB}=31, the UE determines that there is no CD-SSB within the GSCN range

$$[ {N}_{GSCN}^{Reference} + {N}_{GSCN}^{start} , {N}_{GSCN}^{Reference} + {N}_{GS CN}^{end} ]$$

where N_{GSCN}^{Reference} is the GSCN of the measurement SSB of GSCN, N_{GSCN}^{start} and N_{GSCN}^{end} are determined by controlResourceSetZero and searchSpaceZero in pdcch-ConfigSIB1 in MIB, respectively. In this case, the UE may search for CD-SSB outside of the GSCN range.

For non-RedCap UEs, the UE may determine or search for CD-SSB with the above manners. However, the RedCap UEs may have reduced maximum UE bandwidth, reduced number or receiving (Rx) branches, etc. For FR1, the RedCap UEs support maximum 20 MHz UE bandwidth, while the eMBB UEs or URLLC UEs support maximum 100 MHz maximum UE bandwidth.

Furthermore, further reduce the maximum UE bandwidth for the RedCap UEs, for example, 5 MHz maximum UE bandwidth for the RedCap UEs might be deployed in the network.

The present disclosure proposes the solutions for the RedCap UEs to detect the SSB, and the RedCap UEs have a maximum UE bandwidth smaller than the maximum UE bandwidth of the eMBB UEs or URLLC UEs. For example, the maximum UE bandwidth of the RedCap UEs may be 10 MHz, 5 MHz, 4 MHZ, or 3 MHz, etc. Hereinafter the present disclosure uses the RedCap UEs with the bandwidth of 5 MHz as an example, and it should be noted that the solutions of the present disclosure also apply to the RedCap UEs with other bandwidth sizes, or the UEs with smaller bandwidth, or the like.

With 5 MHz maximum UE bandwidth, the RedCap UEs is only compatible with the SSB with 15 kHz SCS, and CORESET #0 with 15 kHz SCS and 24 RBs, which occupies 3.72 MHz bandwidth. Other SSB and CORESET #0 configurations are not compatible with the RedCap UEs with 5 MHz maximum UE bandwidth, since they have bandwidth larger than 5 MHz.

Table 3 below gives a full picture on the backward compatibility of SSB and CORESET #0 for 5 MHz the RedCap UEs with 5 MHz maximum UE bandwidth.

TABLE 3
Compatibility of 5 MHz RedCap UEs
with legacy SSB and CORESET#0

| | | | | Compatible |
|---|---|---|---|---|
| | | CORESET#0 | Compatible | with |
| SSB | CORESET#0 | bandwidth | with SSB | CORESET#0 |
| SCS | SCS | (No. of RBs) | (Y/N) | (Y/N) |
| 15 kHz | 15 kHz | 24 | Y | Y |
| 15 kHz | 15 kHz | 48/96 | Y | N |
| 15 kHz | 30 kHz | 24/48/96 | Y | N |
| 30 kHz | 15 kHz | 24/48/96 | N | N |
| 30 kHz | 30 kHz | 24/48/96 | N | N |

According to table 3, it can be seen that in the first line, the RedCap UE is compatible with both the SSB and CORESET #0. However, in the second line and the third line, the RedCap UE is only compatible with the SSB, but does not compatible with CORESET #0. In the fourth line and the fifth line, the RedCap UE is neither compatible with the SSB, nor compatible with CORESET #0.

As a result, if CD-SSB (15 kHz SCS) and CORESET #0 (15 kHz SCS, 24RB) are configured, the RedCap UEs can access the network like the non-RedCap UEs. However, at network side, it will not always use configurations compatible with the RedCap UEs, since these configurations might not be efficient for non-RedCap UEs. As an example, the 24RB CORESET #0 has fewer resources than 48RB CORESET #0 or 96RB CORESET #0, which might lead to higher scheduling latency and higher PDCCH blocking when there are many UEs waiting for scheduling.

In view of the above, the present disclosure proposes some solutions for the RedCap UEs with 5 MHz maximum bandwidth accessing the network in the case the SSB and/or CORESET #0 are not compatible with the RedCap UEs.

Based on the value of the parameter k_{SSB} and the configuration of CORESET #0, three cases are described in the present disclosure.

Case 1:

The SSB detected by the RedCap UE is a CD-SSB for non-RedCap UEs. In this case, the value of the parameter k_{SSB} is within a range from 0 to 11, and CORESET #0 is configured with 15 kHz SCS; or the value of the parameter k_{SSB} is within a range from 0 to 23, and CORESET #0 is configured with 30 kHz SCS.

Case 1-1:

If k_{SSB} is within [0, 11] and CORESET #0 is configured with 15 kHz SCS and 24 RBs, the CORESET #0 is compatible with the RedCap UEs. The RedCap UEs will continue to detect DCI in CORESET #0 for scheduling SIB1, and then detect SIB1 to get the dedicated configurations for the RedCap UEs.

Case 1-2:

If k_{SSB} is within [0, 11] and CORESET #0 is configured with 15 kHz SCS and 48 RBs or 96 PRBs, CORESET #0 is not compatible with the RedCap UEs. The RedCap UEs will detect a new CORESET, which is defined for the RedCap UEs. The configuration of the new CORESET might be determined fully or partly by CORESET #0, and the new CORESET might or might not be within the bandwidth of CORESET #0. Alternatively, the RedCap UEs may drop this SSB and start to search for another SSB.

Case 1-3:

If k_{SSB} is within [0, 23] and CORESET #0 is configured with 30 kHz SCS and 24, 48, or 96 RBs, CORESET #0 is not compatible with the RedCap UEs. Similarly, the RedCap UEs will detect a new CORESET, which is dedicated for the RedCap UEs, or search for another SSB.

Regarding searching for another SSB, for example, the RedCap UEs may search for a CD-SSB with the value of the parameter k_{SSB} is within a range from 0 to 11, and CORESET #0 is configured with 15 kHz SCS, or search for a dedicated CD-SSB for the RedCap UEs, which is described in case 3 below.

Case 2:

The SSB detected by the RedCap UE is a measurement SSB for the non-RedCap UEs, i.e. a SSB for measurement only. In this case, the value of the parameter k_{SSB} is within a range from 24 to 31.

In this case, the RedCap UEs re-interpret MIB or PBCH payload to find a CD-SSB for the RedCap UEs.

Case 2-1:

If the value of the parameter k_{SSB} is within a range from 23 to 30, a field in MIB is re-interpreted to indicate if the CD-SSBs determined by this measurement SSB is shared with the RedCap UEs or not.

If the determined CD-SSB is shared with the RedCap UEs, the RedCap UEs will detect the CD-SSB correspondingly. In this case, the RedCap UEs and the non-RedCap UEs share the same CD-SSB. If the determined CD-SSB is not shared with the RedCap UEs, the RedCap UEs may search for a CD-SSB that is specific for the RedCap UEs.

Case 2-2:

If the value of the parameter k_{SSB} is 31, a field in MIB is re-interpreted to indicate if there is a CD-SSB for the RedCap UEs within the frequency range

$$[ {N}_{GSCN}^{Reference} + {N}_{GSCN}^{start} , {N}_{GSCN}^{Reference} + {N}_{GS CN}^{end} ]$$

where N_{GSCN}^{Reference} is the GSCN of the measurement SSB of GSCN, N_{GSCN}^{start} and N_{GSCN}^{end} are determined by controlResourceSetZero and searchSpaceZero in pdcch-ConfigSIB1 in MIB, respectively.

If the field indicates that there is a CD-SSB for the RedCap UEs within the frequency range, the RedCap UEs will then search for a CD-SSB in the corresponding frequency range based on the indication.

If the field indicates that there is no CD-SSB for the RedCap UEs within the frequency range, the RedCap UEs may search for CD-SSB outside of the GSCN range, or search for a CD-SSB that is specific for The RedCap UEs.

Case 2-3:

One or more fields in MIB are re-interpreted to indicate a GSCN offset N_{GSCN}^{offset_RedCap_01} which is relative to the GSCN of the measurement SSB of GSCN, i.e. N_{GSCN}^{Reference}. The RedCap UEs are expected to find a CD-SSB with GSCN equal to N_{GSCN}^{Reference}+N_{GSCN}^{offset_RedCap_01}.

Case 2-4:

One or more fields in MIB are re-interpreted to indicate a GSCN offset N_{GSCN}^{offset_RedCap_02}, which is relative to GSCN of CD-SSB for the non-RedCap UEs, i.e., N_{GSCN}^{Reference}+N_{GSCN}^{offset}. The RedCap UEs are expected to find a CD-SSB in N_{GSCN}^{Reference}+N_{GSCN}^{offset}+N_{GSCN}^{offset_RedCap_02}.

Case 2-5:

One or more fields in MIB are re-interpreted to indicate a frequency range for the RedCap UEs to search for a RedCap specific CD-SSB.

The one or more fields in MIB for indicating either of the information in the above embodiments may include the parameters such as: systemFrameNumber, dmrs-TypeA-Position, cellBarred, intraFrequencyReselection, spare in MIB, and PBCH physical payload except the one bit for MSB of k_{SSB}. One field, or a combination of these fields may be used to indicate the frequency offset in case 2-2, case 2-3, and case 2-4.

Case 3:

The SSB detected by the RedCap UE has a configuration of k_{SSB} within a range from 12 to 23, and CORESET #0 with 15 kHz SCS, which is a SSB not interpretable by the non-RedCap UEs.

The present disclosure proposes to use the SSB with such a configuration as a dedicated CD-SSB for the RedCap UEs.

In this case, the subcarrier offset between the SSB first RB and a common RB is k_{SSB}−12. Therefore, the subcarrier offset ranges from 0 to 11.

In the present disclosure, for the dedicated CD-SSB for the RedCap UEs, there is a dedicated MIB for the RedCap UEs, which configures a dedicated CORESET #0 for the RedCap UEs, and there is a DCI transmitted in the CORESET for scheduling RedCap dedicated SIB1. The dedicated CORESET #0 may be configured based on a table, compared with table 1 above, the CORESET #0 configurations may have less CORESET RBs, e.g., 12RBs, 8 RBs, etc., or have more CORESET #0 OFDM symbols, e.g., 4 OFDM symbols.

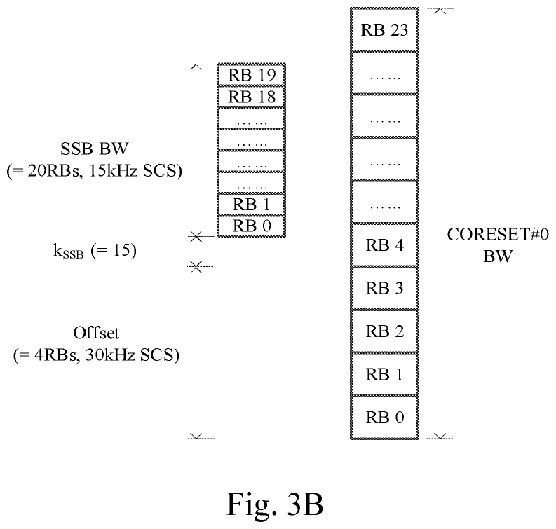

FIG. 4 illustrates an example of determining the position of CORESET #0 in frequency domain based on the position of the detected SSB according to some embodiments of the present disclosure.

In FIG. 4, the SSB SCS is 15 kHz, and CORESET #0 SCS is 15 kHz. The SSB is configured with 20 RBs, which are referred to as RB 0, RB 1, . . . , RB 19. CORESET #0 is configured with 12 RBs, which are referred to as RB 0, RB 1, . . . , RB 11.

One CORESET #0 RB occupies a frequency range corresponding to 1 SSB RB. The RB level offset is −4 RBs, counting using one CORESET #0 RB as the unit. The RB level offset is defined with respect to the SCS of the CORESET #0, from the smallest RB index of the CORESET #0 to the smallest RB index of the common RB overlapping with the first RB of the corresponding SSB.

Specifically, the frequency offset in the dedicated CORESET #0 configuration is interpreted that the starting position of CORESET #0 has higher position in frequency domain than that of SSB RB0, which is different with the relative position of CORESET #0 and SSB in FIGS. 3A and 3B, wherein the starting position of CORESET #0 has lower position in frequency domain than that of SSB RB0.

The subcarrier offset is 5 subcarriers, counting using 15 kHz numerology. Therefore, the total offset in frequency domain is: −4 CORESET #0 RBs and 5 subcarriers.

Table 4 below provides an example on the dedicated CORESET #0 configuration for the RedCap UEs. Compared with table 1 for the non-RedCap UEs, table 4 supports 12 RB CORESET, 4 OFDM symbols. The RB offset with “*” means the CORESET #0 starting position is lower in frequency than that of SSB RB0. That is, the value of e.g., 4*, means that the frequency offset is −4RBs.

TABLE 4
CORESET configurations for the RedCap UEs

| | Number | Number of | |
|---|---|---|---|
| Index | of RBs | Symbols | Offset(RBs) |
| 0 | 24 | 2 | 0 |
| 1 | 24 | 2 | 2 |
| 2 | 24 | 2 | 4 |
| 3 | 24 | 3 | 0 |
| 4 | 24 | 3 | 2 |
| 5 | 24 | 3 | 4 |
| 6 | 24 | 4 | 0 |
| 7 | 24 | 4 | 2 |
| 8 | 24 | 4 | 4 |
| 9 | 12 | 3 | 0 |
| 10 | 12 | 3 | 2* |
| 11 | 12 | 3 | 4* |
| 12 | 12 | 4 | 0 |
| 13 | 12 | 4 | 2* |
| 14 | 12 | 4 | 4* |

| | |
|---|---|
| 15 | Reserved |

It should be noted that table 4 is an exemplary CORESET configurations for the RedCap UEs, and other CORESET configurations are not limited here.

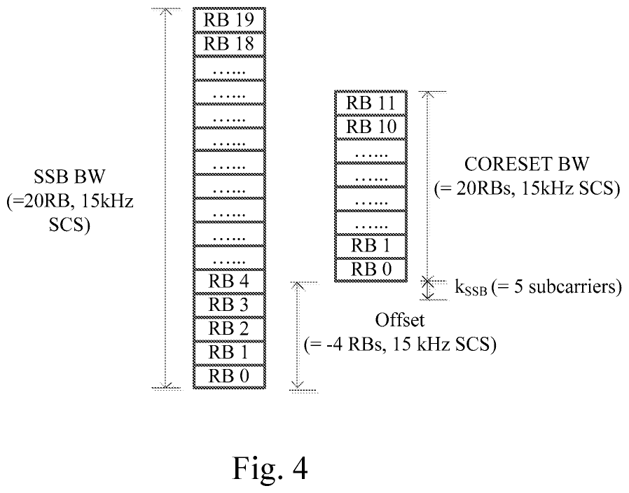

FIG. 5 illustrates a method performed by a UE for wireless communication according to some embodiments of the present disclosure. Specifically, the UE may be a RedCap UE.

In step 501, the UE determines at least one of a value of a first parameter and a configuration of a first CORESET associated with a first SSB. The first parameter may be referred to as k_{SSB}, and the first CORESET may be referred to as CORESET #0. In step 502, the UE determines a type of the first SSB based on at least one of the value of the first parameter and the configuration of the first CORESET. In step 503, the UE determines a cell defining SSB for the UE based on the type of the first SSB; or determines a frequency range for searching the cell defining SSB for the UE based on the type of the first SSB.

In some embodiments, the UE determines the type of the first SSB is the cell defining SSB for the UE when the first parameter is within a range from 0 to 11, and the configuration indicates the first CORESET is configured with a SCS of 15 kHz and 24 resource blocks. For example, in case 1-1, the RedCap UE determines the detected SSB is a CD-SSB for the RedCap UE when the parameter k_{SSB} is from 0 to 11, and CORESET #0 is configured with a SCS of 15 kHz and 24 resource blocks.

In some embodiments, the UE determines the type of the first SSB is not the cell defining SSB for the UE and detects a second CORESET and/or a second SSB when the first parameter is within a range from 0 to 11, and the configuration indicates the first CORESET is configured with a SCS of 15 kHz and 48 or 96 resource blocks. For example, in case 1-2, the RedCap UE determines the detected SSB is not a CD-SSB for the RedCap UE when the parameter k_{SSB} is from 0 to 11, and CORESET #0 is configured with a SCS of 15 kHz and 48 or 96 resource blocks. The RedCap UE then detects a new CORESET and/or a dedicated SSB for the RedCap UE.

In some embodiments, the UE determines the type of the first SSB is not the cell defining SSB for the UE and detects a second CORESET and/or a second SSB when the first parameter is within a range from 0 to 23, and the configuration indicates the first CORESET is configured with a SCS of 30 kHz. For example, in case 1-3, the RedCap UE determines the detected SSB is not a CD-SSB for the RedCap UE when the parameter k_{SSB} is from 0 to 23, and CORESET #0 is configured with a SCS of 30 kHz. The RedCap UE then detects a new CORESET and/or a dedicated SSB for the RedCap UE.

In some embodiments, the UE determines the type of the first SSB is not a cell defining SSB for the UE; determines a second SSB based on the first SSB; determines whether the second SSB is a cell defining SSB for the UE based on a field in broadcast information; and the UE detects the second SSB if it is a cell defining SSB; or detects a cell defining SSB for the UE if the second SSB is not the cell defining SSB. For example, in case 2-1, the RedCap UE determines the detected SSB is not a CD-SSB for the RedCap UE, and it is a measurement SSB for the non-RedCap UEs. The RedCap UE then determines a CD-SSB for the non-RedCap UEs based on the measurement SSB, and determines whether the CD-SSB for the non-RedCap UEs is also a CD-SSB for the RedCap UE based on a field in MIB. If yes, the RedCap UE detects the CD-SSB for the non-RedCap UEs, if not, the RedCap UE may search for a CD-SSB that is specific for the RedCap UEs.

In some embodiments, the UE determines the type of the first SSB is not a cell defining SSB for the UE; determines whether there is a cell defining SSB for the UE within the frequency range based on a field in broadcast information; and detects the cell defining SSB for the UE within the frequency range; or detects a cell defining SSB for the UE out of the frequency range. For example, in case 2-2, the RedCap UE determines the detected SSB is not a CD-SSB for the RedCap UE, it is a measurement SSB for the non-RedCap UEs. The RedCap UE then determines whether there is a CD-SSB within the frequency range based on a field in MIB. If yes, the RedCap UE detects the CD-SSB for the RedCap UEs within the frequency range, if not, the RedCap UE may search for a CD-SSB out of the frequency range. Or the RedCap UE may search for a CD-SSB that is specific for the RedCap UEs.

In some embodiments, the UE determines the type of the first SSB is not a cell defining SSB for the UE; determines a frequency offset for a cell defining SSB for the UE based on one or more fields in broadcast information; and detects a cell defining SSB for the UE based on the frequency offset. For example, in case 2-3 and 2-4, the RedCap UE determines the detected SSB is not a CD-SSB for the RedCap UE, it determines a frequency offset for a CD-SSB for the UE based on one or more fields in MIB; and detects a CD-SSB for the UE based on the frequency offset. Specifically, in case 2-3, the frequency offset is associated with a frequency position of the first SSB, in case 2-4, the frequency offset is associated with a frequency position of a second SSB.

In some embodiments, the UE determines the first SSB as a cell defining SSB for the UE if the first parameter is within a range from 12 to 23, and the first CORESET is configured with a SCS of 30 kHz. For example, in case 3, the first SSB is an SSB not interpretable by non-RedCap UEs, and is considered as the dedicated CD-SSB for the RedCap UEs.

In some embodiments, the subcarrier offset between a first resource block (RB) of the first SSB and a common RB is the first parameter minus 12.

In some embodiments, a dedicated master information block in the first SSB indicates a dedicated CORESET for the UE. For example, in case 3, there is a dedicated MIB for the RedCap UEs, which configures a dedicated CORESET #0 for RedCap UEs.

In some embodiments, a configuration of the dedicated CORESET includes less resource blocks (RB) than 24 RBs and/or more than 3 orthogonal frequency division multiplexing (OFDM) symbols. For example, as can be seen in table 4 above, in the 9^{th} row, the index is 8, the number of RBs for the dedicated CORESET is 12, and the number of OFDM symbols is 4.

In some embodiments, a starting position of the dedicated CORESET for the UE is higher than a starting position of the first SSB in frequency domain. For example, in FIG. 4, the starting position of RB 0 of the dedicated CORESET is higher than a starting position of RB 0 of the first SSB in frequency domain.

In should be noted that although some embodiments are described with the RedCap UEs, the solutions in the present disclosure also apply to other types of UEs.

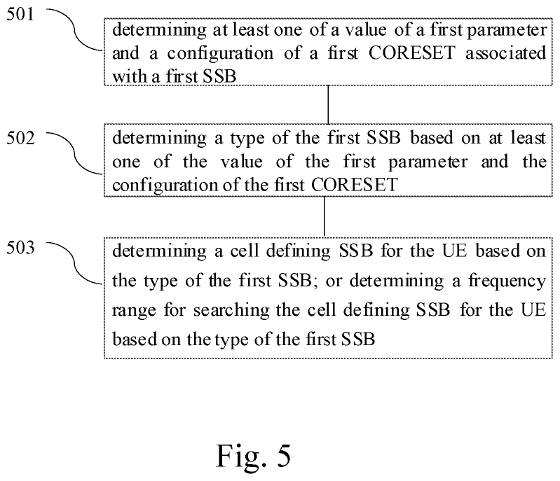

FIG. 6 illustrates a method performed by a BS for wireless communication according to some embodiments of the present disclosure.

In step 601, the BS determines whether a first SSB is a cell defining SSB for a UE based on at least one of a value of a first parameter and a configuration of a first CORESET associated with a first SSB. In step 602, the BS transmits the first SSB. For example, in case 1 and case 3, the BS determines whether the first SSB is a CD-SSB for the UE based on the parameter k_{SSB} and/or CORESET #0, then the BS transmits the first SSB.

In step 603, the BS determines a cell defining SSB for the UE based on the first SSB, or determines a frequency range for transmitting the cell defining SSB for the UE in case the first SSB is not the cell defining SSB for the UE. In step 604, the BS transmits the cell defining SSB for the UE. For example, in case 2, the BS determines that the first SSB is not a CD-SSB for the UE, but a measurement SSB, the BS then determines the CD-SSB based on the measurement SSB.

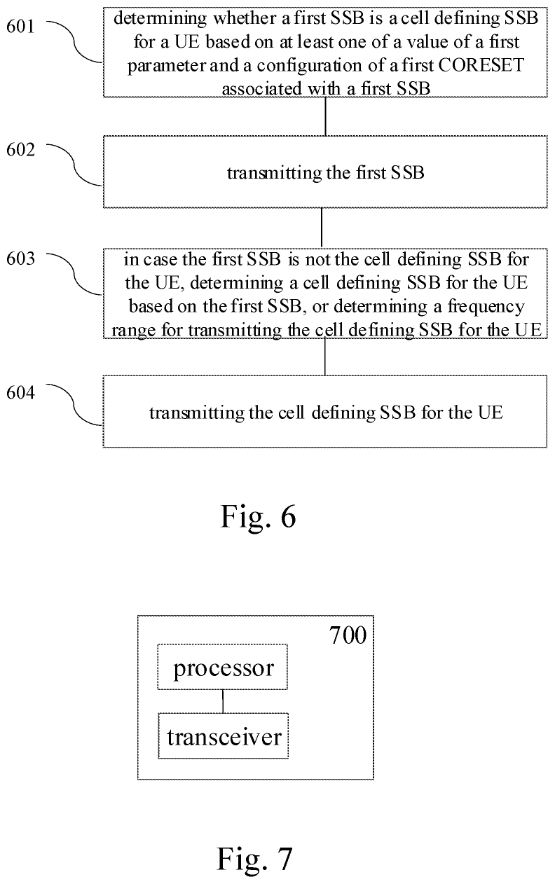

FIG. 7 illustrates a simplified block diagram of an exemplary apparatus 700 according to some embodiments of the present disclosure. The apparatus 500 may be or include at least a part of a BS (e.g., BS 102) or a UE (for example, UE 101-A or UE 101-B) or other device with similar functionality.

The apparatus 700 may include a transceiver and a processor, and the transceiver is coupled to the processor. In some embodiments, the transceiver may include a transmitter and a receiver. The processor is configured to perform any of the methods described in the present disclosure, for example, the method described with respect to FIG. 5 or FIG. 6. For example, when the apparatus 700 is implemented as a UE, the processor may determine at least one of a value of a first parameter and a configuration of a first CORESET associated with a first SSB. The first parameter may be referred to as k_{SSB}, and the first CORESET may be referred to as CORESET #0. The UE may determine a type of the first SSB based on at least one of the value of the first parameter and the configuration of the first CORESET. The UE may determine a cell defining SSB for the UE based on the type of the first SSB; or determines a frequency range for searching the cell defining SSB for the UE based on the type of the first SSB.

When the apparatus 700 is implemented as a BS, the processor may determine whether a first SSB is a cell defining SSB for a UE based on at least one of a value of a first parameter and a configuration of a first CORESET associated with a first SSB, and the transceiver may transmit the first SSB. The processor may determine a cell defining SSB for the UE based on the first SSB, or determines a frequency range for transmitting the cell defining SSB for the UE in case the first SSB is not the cell defining SSB for the UE, and the transceiver may transmit the cell defining SSB for the UE.

In some other embodiments, the processor may be configured to perform any of the methods described in the present disclosure by executing instructions stored on a medium (not shown in FIG. 7).

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus, including a processor and a memory. Computer programmable instructions for implementing a method for SSB detection are stored in the memory, and the processor is configured to perform the computer programmable instructions to implement the method for SSB detection. The method for SSB detection may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for SSB detection according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE), comprising:
at least one memory; and
at least one processor coupled to the at least one memory and configured to cause the UE to:
determine at least one of a value of a first parameter and a configuration of a first control resource set (CORESET) associated with a first synchronization signal and physical broadcast channel block (SSB);
determine a type of the first SSB based on at least one of the value of the first parameter and the configuration of the first CORESET; and
determine a cell defining SSB for the UE based on the type of the first SSB; or
determine a frequency range for searching the cell defining SSB for the UE based on the type of the first SSB.

2. The UE of claim 1, wherein the at least one processor is further configured to cause the UE to:
determine the type of the first SSB is the cell defining SSB for the UE when the first parameter is within a range from 0 to 11, and the configuration indicates the first CORESET is configured with a subcarrier spacing (SCS) of 15 kHz and 24 resource blocks.

3. The UE of claim 1, wherein the at least one processor is further configured to cause the UE to:
determine the type of the first SSB is not the cell defining SSB for the UE and detecting detect a second CORESET or a second SSB when the first parameter is within a range from 0 to 11, and the configuration indicates the first CORESET is configured with a subcarrier spacing (SCS) of 15 kHz and 48 or 96 resource blocks.

4. The UE of claim 1, wherein the at least one processor is further configured to cause the UE to:
determine the type of the first SSB is not the cell defining SSB for the UE and detect a second CORESET and/or a second SSB when the first parameter is within a range from 0 to 23, and the configuration indicates the first CORESET is configured with a subcarrier spacing (SCS) of 30 kHz.

5. The UE of claim 1, wherein the at least one processor is further configured to cause the UE to:
determine the type of the first SSB is not a cell defining SSB for the UE;
determine a second SSB based on the first SSB;
determine whether the second SSB is a cell defining SSB for the UE based on a field in broadcast information; and
detect the second SSB if it is a cell defining SSB; or
detect a cell defining SSB for the UE if the second SSB is not the cell defining SSB.

6. The UE of claim 1, wherein the at least one processor is further configured to cause the UE to:
determine the type of the first SSB is not a cell defining SSB for the UE;
determine whether there is a cell defining SSB for the UE within the frequency range based on a field in broadcast information; and
detect the cell defining SSB for the UE within the frequency range; or
detect a cell defining SSB for the UE out of the frequency range.

7. The UE of claim 1, wherein the at least one processor is further configured to cause the UE to:
determine the type of the first SSB is not a cell defining SSB for the UE;
determine a frequency offset for a cell defining SSB for the UE based on one or more fields in broadcast information; and
detect a cell defining SSB for the UE based on the frequency offset.

8. The UE of claim 7, wherein the frequency offset is associated with a frequency position of the first SSB or a second SSB.

9. The UE of claim 1, wherein the at least one processor is further configured to cause the UE to:
determine the first SSB as a cell defining SSB for the UE if the first parameter is within a range from 12 to 23.

10. The UE of claim 9, wherein a subcarrier offset between a first resource block (RB) of the first SSB and a common RB is the first parameter minus 12.

11. The UE of claim 1, wherein a dedicated master information block in the first SSB indicates a dedicated CORESET for the UE.

12. The UE of claim 11, wherein a configuration of the dedicated CORESET includes less resource blocks (RB) than 24 RBs and/or more than 3 orthogonal frequency division multiplexing (OFDM) symbols.

13. The UE of claim 11, wherein a starting position of the dedicated CORESET for the UE is higher than a starting position of the first SSB in frequency domain.

14. A base station (BS), comprising:
at least one memory; and
at least one processor coupled to the at least one memory and configured to cause the BS to:
determine whether a first SSB is a cell defining SSB for a user equipment (UE) based on at least one of a value of a first parameter and a configuration of a first control resource set (CORESET) associated with a first synchronization signal and physical broadcast channel block (SSB); and
when the first SSB is not the cell defining SSB for the UE, determine a cell defining SSB for the UE based on the first SSB or determine a frequency range for transmitting the cell defining SSB for the UE;
transmit the first SSB; and
transmit the cell defining SSB for the UE when the first SSB is not the cell defining SSB for the UE.

15. A method performed by a user equipment (UE), the method comprising:
determining at least one of a value of a first parameter and a configuration of a first control resource set (CORESET) associated with a first synchronization signal and physical broadcast channel block (SSB);
determining a type of the first SSB based on at least one of the value of the first parameter and the configuration of the first CORESET; and
determining a cell defining SSB for the UE based on the type of the first SSB; or
determining a frequency range for searching the cell defining SSB for the UE based on the type of the first SSB.

16. A processor for wireless communication comprising:
at least one controller coupled with at least one memory and configured to cause the processor to:
determine at least one of a value of a first parameter and a configuration of a first control resource set (CORESET) associated with a first synchronization signal and physical broadcast channel block (SSB);
determine a type of the first SSB based on at least one of the value of the first parameter and the configuration of the first CORESET; and
determine a cell defining SSB for the UE based on the type of the first SSB; or
determine a frequency range for searching the cell defining SSB for the UE based on the type of the first SSB.

17. The processor of claim 16, wherein the at least one controller is further configured to cause the processor to:
determine the type of the first SSB is the cell defining SSB for the processor when the first parameter is within a range from 0 to 11, and the configuration indicates the first CORESET is configured with a subcarrier spacing (SCS) of 15 kHz and 24 resource blocks.

18. The processor of claim 16, wherein the at least one controller is further configured to cause the processor to
determine the type of the first SSB is not the cell defining SSB for the processor and detect a second CORESET or a second SSB when the first parameter is within a range from 0 to 11, and the configuration indicates the first CORESET is configured with a subcarrier spacing (SCS) of 15 kHz and 48 or 96 resource blocks.

19. The processor of claim 16, wherein the at least one controller is further configured to cause the processor to:
determine the type of the first SSB is not the cell defining SSB for the processor and detect a second CORESET and/or a second SSB when the first parameter is within a range from 0 to 23, and the configuration indicates the first CORESET is configured with a subcarrier spacing (SCS) of 30 kHz.

20. The processor of claim 16, wherein the at least one controller is further configured to cause the processor to:
determine the type of the first SSB is not a cell defining SSB for the processor,
determine a second SSB based on the first SSB;
determine whether the second SSB is a cell defining SSB for the processor based on a field in broadcast information; and
detect the second SSB if it is a cell defining SSB; or
detect a cell defining SSB for the UE if the second SSB is not the cell defining SSB.
